(19) United States
(12) Patent Application Publication
(10) Pub. No.: US 2002/0023120 A1
(43) Pub. Date: Feb. 21, 2002

(54) Method of playing multimedia data

(76) Inventor: Philippe Gentric, Issy Les Moulineaux (FR)

Correspondence Address: U.S. Philips Corporation, 580 White Plains Road, Tarrytown, NY, 10591, US

(21) Appl. No.: 09/929,130

(22) Filed: Aug. 14, 2001

(30) Foreign Application Priority Data
Aug. 16, 2000 (EP) 00402294.3

(51) Int. Cl. G06F 17/00; G06F 9/00

(52) U.S. Cl. 709/107; 700/94

(57) ABSTRACT

The present invention relates to a multimedia player providing a generic and easy to use mechanism for accurate task scheduling. Said multimedia player processes a encoded digital data stream (IS) in order to supply audio and video signals (SO, SC) to an audio-visual production system (LS, MON). The multimedia player in accordance with the invention comprises a demultiplexer (DEMUX) for splitting the encoded digital data stream into an audio stream (AS) and several video streams (VS1 to VSn). The multimedia player also performs the tasks of audio decoding and rendering (DR), to decode (ADEC) the audio stream, to filter the decoded audio frames (AF) provided by the decoding and to render (AREN) said audio frames; decoding (DEC) the video streams, to provide video objects whose decoded video frames (VF1 to VFn) are stored in video buffers (BUF1 to BUFn); and rendering (REN) the decoded video frames stored in the video buffers. Finally, the multimedia player comprises a scheduler for registering the three previous tasks, assigning a target time to said tasks, and controlling the execution of the tasks as a function of the target time.

### FIELD OF THE INVENTION

The present invention relates to a method of playing multimedia frames comprised in a encoded digital data stream on a computer running a multitasking operating system, said method comprising the steps of:

audio decoding and rendering, to decode an audio stream contained in the encoded digital data stream and to render the decoded audio frames provided by the decoding,

decoding at least one video stream contained in the encoded digital data stream, to supply

decoded video frames to a video buffer, and rendering the decoded video frames stored in the video buffer.

Such a method may be used in, for example, an MPEG-4 player which allows audio and video frames previously encoded using the MPEG-4 standard to be reproduced on a computer.

### BACKGROUND OF THE INVENTION

An audio-video player is a program running on a computer that decodes audio and video streams in order to produce an audio-visual presentation. FIG. 1 is a block diagram of a method of playing audio and video frames in accordance with the prior art. Said method plays MPEG-4 data and comprises a demultiplexing step (DEMUX) for splitting an MPEG-4 encoded data stream (IS) into an audio stream (AS) and several video streams (VS1 to VSn). Such a method comprises three main tasks.

It firstly comprises an audio decoding and rendering task (DR). This task decodes an audio stream (AS) and drives the sound rendering system by providing decoded audio samples to sound system hardware. The sound system hardware converts these digital audio samples into an analog sound signal (SO), which is sent to loudspeakers (LS).

It also comprises a video decoding task (DEC). This task decodes at least one video stream (VS) and stores the decoded video frames in a video frame buffer (BUF).

Finally, it comprises a video rendering task (REN). This task takes the decoded video frames (VF) from the video frame buffer and supplies pixels corresponding to the decoded video frames to video system hardware in order to compose a video scene (SC). The video rendering step also performs all the video frame conversions which are necessary to drive a monitor (MON).

### SUMMARY OF THE INVENTION

It is an object of the invention to disclose a method of playing multimedia frames on a computer running a multitasking operating system, which allows a better synchronization and real-time playing of audio and video frames. The present invention takes the following aspect into consideration.

Synchronization of audio and video frames, hereinafter referred to as “lipsynchronization”, is a key feature for an audio-video player. Indeed the human perception system is very sensitive to audio and video synchronization, especially when someone is speaking, hence the term lip-synchronization. This is due to the fact that speech recognition is performed by the human brain using lip-reading in correlation with hearing. Furthermore, in many movie scenes accurate synchronization of events is also very important. For examples, it is very annoying to hear the bang of a gun before the gun is fired or to have hand motions of instrument players not synchronized with the sound.

On the one hand, measurements during extensive user tests performed when tuning MPEG-2 products showed that users can detect a time difference between audio and video streams of around 20 milliseconds. In a more general way, it has been observed that a “normal” user can hardly notice differences smaller than 50 milliseconds. On the other hand, a time difference larger than 300 milliseconds for example completely spoils the viewer's experience. Sometimes it may even become difficult to actually follow what is going on in the movie.

That is why playing audio and video frames on a computer running a multitasking operating system depends on the scheduling strategy implemented in the operating system kernel, which makes the synchronization of audio and video frames difficult.

To overcome the limitations of the prior art, the method of playing multimedia frames in accordance with the invention is characterized in that it comprises a scheduling step (SCH) for registering the audio and video decoding and rendering steps, assigning a target time to said steps, and controlling the execution of the steps as a function of the target time.

Such a scheduling of audio and video decoding and rendering steps, as compared with generic scheduling strategies such as the ones implemented in operating system kernels, allows audio and video frames to remain synchronized while a real time playing is maintained. For that purpose, three specific embodiments are proposed.

In the first one, the method of playing multimedia frames is characterized in that the scheduling step is adapted to control the execution of the video rendering step by skipping the rendering of video frames as a function of the target time.

Such a feature allows video frames to be played more slowly than at the original frame rate by skipping frames when required central processing unit (hereinafter referred to as CPU) resources are not available to keep audio and video frames synchronized. It should be noted that this is not a slow motion but a rendering of fewer images than the original content has. For example, a 25 frames per second video sequence can be played at 20 frames per second.

In the second embodiment, the method of playing multimedia frames is characterized in that the scheduling step is adapted to control the execution of the video decoding step by stopping the decoding at a given video frame and resuming it at a following video frame as a function of the target time.

Video playing has been split in two steps so that, firstly, video rendering can be skipped while video decoding is maintained and, secondly, both video rendering and decoding are skipped. This is due to the fact that the video rendering step performs all the tasks of image format conversion, which are much more CPU intensive than the video decoding step.

In the third embodiment, the method of playing multimedia frames is characterized in that the scheduling step is adapted to control the execution of the audio decoding and rendering step by skipping the audio decoding at a given audio frame and resuming it at a following audio frame as a function of the target time.

Audio frames have to be played at exactly the normal rate, otherwise very audible artifacts are produced. For example, if the sound was sampled at a sampling frequency of 44 kHz and is decoded with an output frequency of 40 kHz, it would sound wrong because the sound has been shifted toward the low frequencies. Moreover, if the component driving a sound reproduction system, a loudspeaker for example, suffers an input buffer overflow, audio data will be lost and it will cause a bad synchronization with video data. The method of playing multimedia frames in accordance with the invention allows audio frames to be played at the right frequency by skipping the audio decoding and producing instead sound samples corresponding to a silence in order to fill the buffer.

In addition to this third embodiment, the method of playing audio and video frames is characterized in that the audio decoding and rendering step comprises a sub-step of filtering the decoded audio frames to remove noise at a beginning and end of a silence resulting from skipping of the audio decoding.

If the component driving the sound reproduction system suffers an input buffer underflow, a silence will be produced. However, since this silence is very short, i.e. a few milliseconds, it will result in a quite audible noise like a “scratch” or a “click”. That is why the method of playing multimedia frames in accordance with the invention comprises a filtering sub-step in order to prevent this abrupt interruption of the audio signal.

These and other aspects of the invention will be apparent from and elucidated with reference to the embodiments described hereinafter.

### BRIEF DESCRIPTION OF THE DRAWINGS

The present invention will now be described, by way of example, with reference to the accompanying drawings, wherein:

FIG. 1 is a block diagram of a method of playing multimedia frames in accordance with the prior art, and FIG. 2 is a block diagram of a method of playing multimedia frames in accordance with the invention.

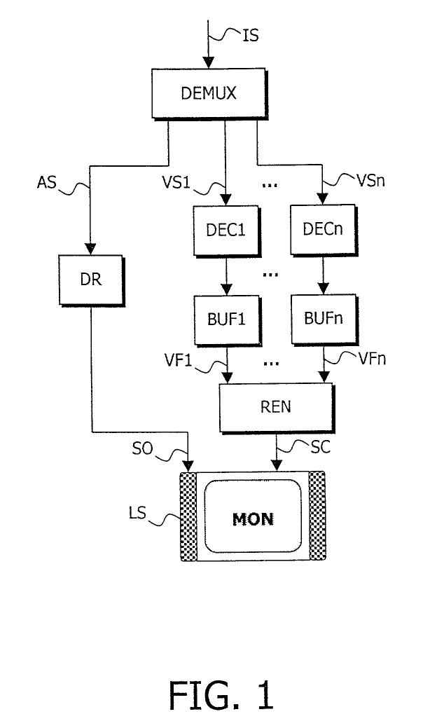

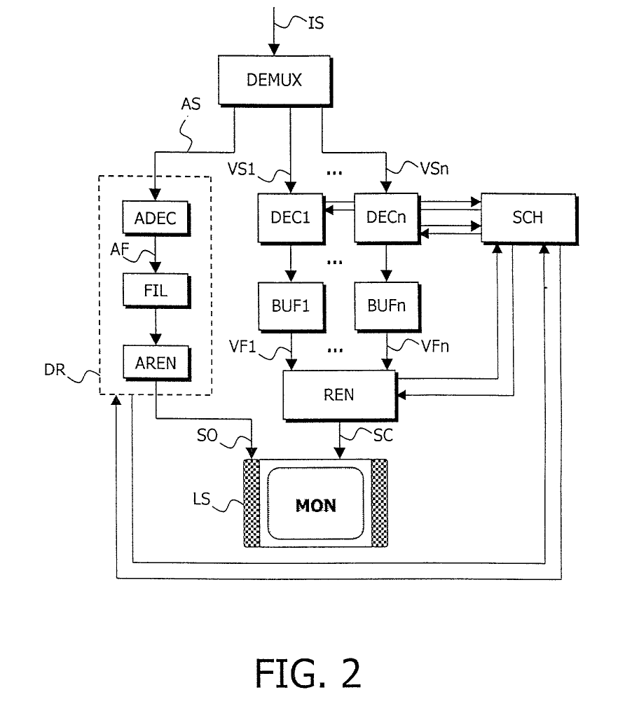

### DETAILED DESCRIPTION OF THE INVENTION

The present invention relates to a multimedia player providing a generic and easy to use mechanism for accurate task scheduling. FIG. 2 is a block diagram of said multimedia player which processes a encoded digital data stream (IS) in order to provide audio and video signals (SO, SC) to an audio-visual reproduction system (LS, MON).

In the preferred embodiment, the multimedia player is an MPEG-4 player and firstly comprises a demultiplexer (DEMUX) for splitting the encoded digital data stream into an audio stream (AS) and several video streams (VS1 to VSn).

The MPEG-4 player in accordance with the invention comprises the tasks of:

audio decoding and rendering (DR), to decode (ADEC) the audio stream, to filter (FIL) the decoded audio frames (AF) provided by the decoding, and to render (AREN) said audio frames,

decoding (DEC) the video streams, to provide video objects, whose decoded video frames (VF1 to VFn) are stored in video buffers (BUF1 to BUFn), and

rendering (REN) the decoded video frames stored in the video buffers.

Finally, the MPEG-4 player comprises a scheduler for registering the three previous tasks, assigning a target time to said tasks, and controlling the execution of the tasks as a function of the target time.

First of all, a scheduler is defined as a software module in which tasks can be registered. Once a task has been registered, the scheduler ensures that said task is executed at the right time. The scheduler is initialized with a scheduling periodicity. For example, for a 25 frames per second video sequence the periodicity is 40 milliseconds. The scheduler manages a loop on the tasks: it executes each task in the list of registered tasks, one after the other. A task is executed by calling its execution routine.

One major role of the scheduler is to maintain the target time. The target time is computed by the scheduler using the system clock. For example, if the video sequence has started at 12:45:33, the media time is 22 seconds after 22 seconds of playing and is computed from the system clock which is then 12:45:55. The scheduler ensures that the video and audio decoding executed at that time correspond to data in the encoded digital data stream having a media time of 22 seconds.

An aim of the scheduler is to make sure that the player does not run too fast and is friendly to other tasks and programs. For that reason, the scheduler computes at the end of each loop the effective time that has elapsed for its execution and compares it with the scheduling periodicity. If the execution of this loop takes less than the scheduling periodicity, the scheduler will call an operating system sleep for the time difference, thus effectively ensuring that, firstly, the player does not run too fast and, secondly, the player is friendly to other tasks or applications, since a sleep call to the operating system results in the operating system kernel swapping to other tasks and applications.

Another aim of the scheduler is to make sure that the player does not run too slowly. For this reason the scheduler assigns the target time to each task execution routine. Each task then knows what to do for that time.

In a multitasking environment the operating system can never guarantee that an application has enough resources at its disposal at a given time. In our case the player may lack CPU cycles at a given time because the user has started another application. When this occurs, a given task may not have enough CPU cycles to perform what it should do in order to meet the target time.

A typical example is a video decoder whose last execution call occurred at media time 2200 milliseconds and which is called again with a target time of 2282 milliseconds. The video decoder will examine the encoded digital data stream for media time stamps and discover that, in order to reach this target time, it must decode two video frames, assuming that each frame duration is 40 milliseconds. The video decoder will decode these two frames but this may take much more than 82 milliseconds because the operating system is executing another high priority application at the same moment and this task can be finished after 300 milliseconds have actually elapsed. In this case, the scheduler will not call a sleep because that would be worse since the player is already late. Instead, the scheduler will again call the video decoder with a new target time of 2612 milliseconds, which the video decoder will try to reach by decoding 8 frames ((2612-2282)/40=8.25). If the decoder is very fast and if this is the only task being executed, said decoder may decode the video frames in a few milliseconds and the player will then be on schedule again. However, if the high priority application is not finished, the player may even be later. Obviously, it can get worse for every new iteration. One can easily see that the player will very rapidly be out of real time.

In order to preclude this drawback, each task keeps track of the previous target time and implements three CPU scalability mechanisms. So, when the difference between the previous target time and the new one becomes larger than a given threshold, the task will reduce the amount of processing it will perform so as to enable the player to resynchronize.

The three specific CPU scalability mechanisms implemented in each task will now be described in more detail. The order of the presentation of these mechanisms is important because this is the order in which each mechanism is used for an optimal efficiency of the player, depending on how badly the player is beyond schedule, though it is also possible to use these mechanisms in a different order.

CPU Scalability Mechanism of the Video Rendering Task:

The first mechanism to keep the player synchronized is to skip rendering frames when the CPU is too busy.

With the above-described scheduler, this is implemented as follows: when the video rendering task (REN) receives an execution call with a target time, it addresses the video frame buffer (BUF) to find the video frame (VF) closest to this target time. Then the video rendering task displays only that frame and returns. The resulting effect of this algorithm is the following: if there are not enough CPU cycles, an original video sequence at 25 frames per second will be rendered at a lower frame rate, for example 12 frames per seconds.

This is the primary CPU scalability mechanism of the player in accordance with the invention. It is a very efficient mechanism that allows the MPEG-4 player in accordance with the invention to run on machines that would otherwise not be powerful enough. It also makes it possible to run other applications at the same time. What the user sees is only that if the CPU is very busy, the video frame rate will be lower. CPU scalability mechanism of the video decoding task:

This second CPU scalability mechanism consists in skipping video decoding when the first mechanism was not enough to keep pace with real time.

However, MPEG-4 video decoding and, more generally, most other video encoding schemes, cannot be resumed at any point in the digital encoded data stream. This is due to the fact that the video encoding algorithm extracts time redundancies between adjacent frames in order to improve encoding efficiency. These frames are called predicted or P frames: the encoder only sends the difference between the current frame and the previous one. In that case, the previous frame must have been decoded. The video standard also normalizes another kind of frames called Intra coded or I frames, which can be decoded alone. These frames are random access points, which are points in the encoded digital data stream where decoding can start.

Therefore, when the video decoding task (DEC) decides to skip decoding, the video display freezes the last picture until the target time corresponding to a random access point is reached. A video sequence is typically encoded with an I frame every second. As a consequence, the scheduler stops the video decoding and resumes it depending on the amount of CPU cycles available, which is equivalent to an extreme reduction of the video frame rate.

Since the video freeze is rather confusing for the user, this strategy is used only when the first CPU mechanism fails to help the player keeping pace with real time.

Since the scheduler loops rapidly on the three major tasks, typically at the video frame rate, audio data should be synchronous with video data. CPU scalability mechanism of the audio decoding and rendering task:

This third mechanism consists in skipping audio decoding if the two previous mechanisms were not enough to keep pace with real time.

Such a mechanism causes a silence. That is why suitable filters (FIL) are applied to prevent a scratching noise at the beginning and end of this unnatural silence. The audio decoding task (ADEC) has to effectively produce the sound samples corresponding to this silence. In that case, the target time provided by the scheduler (SCH) is used to compute the exact length of this silence so that, when the CPU is less busy, normal playing can be resumed with accurate lip-synchronization.

Fortunately, audio encoding algorithms are such that the random access point periodicity is much smaller than for video encoding. It is usually in the range of a few milliseconds. Therefore, normal audio decoding can be resumed immediately.

Since this mechanism is the last to come, the player effectively behaves as if the audio decoding and rendering task had the highest priority, i.e. if audio decoding should stop then video would already be frozen. Since audio decoding is usually less CPU-intensive than video decoding, this typically happens only when the computer is extremely busy with time-critical tasks or when the user has started many CPU-intensive applications.

The scheduler is implemented as a single operating system task. This contrasts with other implementations using threads that are lightweight tasks for the operating system. This has several advantages.

Operating systems have an internal scheduler in their kernel. However, the key purpose of this scheduler is different, because it serves to allow several tasks to share machine resources and is therefore not well fit for the specific issues of audio video playback scheduling.

Operating system scheduling policies depend on the operating system (pre-emptive, time slice, etc), resulting in potential portability issues.

The fewer tasks the operating system has to manage, the better the overall performance of the computer is.

The accurate synchronization of multiple threads is difficult to implement.

The player time management is fully deterministic because calls to the system clock are performed only by the scheduler; this results in a method where real time aspects, managed by the scheduler, are neatly separated from the data processing itself, managed by the tasks.

The player is easier to develop, debug, test, tune and maintain.

Note that this does not preclude the use of separate threads driven by the scheduler tasks.

On the contrary, another advantage of the scheduler is that a separate decoding thread can be launched and paced so that scheduler sleep times can be used for data decoding.

The present application describes a scheduler and its use in the context of MPEG-4 audio and video decoding and playback. In conjunction with ordered specific decoding and rendering tasks this scheduler allows:

a lip-synchronization of video and audio data with an accuracy better than the scheduling periodicity,

CPU scalability mechanisms ensuring that synchronization is kept, even when there are less CPU cycles available for the player than would actually be necessary, these mechanisms also ensuring that the degradation in the playback user experience is gradual, with first a lower video frame rate, then a video freeze and resume, then with silences in the audio track.

The multimedia player has been described for application to MPEG-4 data, for which the decoding complexity is extremely variable so that the CPU load has to be managed carefully so as to avoid CPU cycle waste. However, it is also applicable to other coding techniques which provide multimedia data.

This scheduler is especially useful in the context of a computer running a multitasking operating system such as “Windows”, when many different tasks and programs run in parallel. In such a context, the number of CPU cycles available for multimedia data playing is unpredictable as the user may start, for example, another application during data playback. However, the scheduler is also useful in the context of set-top-boxes, as set-top-boxes are now very close to computers, and can run multiple programs with rich multimedia experience and interactive application.

Note that the player can read the digital encoded data streams from a local storage or can receive them from a broadcast or network. As far as the scheduling mechanism is concerned, this is exactly the same. Its purpose is to provide a generic easy to use mechanism for accurate task scheduling.

The drawing of FIG. 2 is very diagrammatic and represents only one possible embodiment of the invention. Thus, although this drawing shows different functions as different blocks, this by no means excludes the possibility that a single software item carries out several functions. Nor does it exclude the possibility that an assembly of software items carries out a function.

The player in accordance with the invention can be implemented in an integrated circuit, which is to be integrated into a set top box or a computer. A set of instructions that is loaded into a program memory causes the integrated circuit to realize said player. The set of instructions may be stored on a data carrier such as, for example, a disk. The set of instructions can be read from the data carrier so as to load it into the program memory of the integrated circuit which will then fulfil its role.

It will be obvious that the use of verb “to comprise” and its conjugations does not exclude the presence of any other steps or elements than those defined in any claim. Any reference sign in the following claims should not be construed as limiting the claim.

1. A method of playing multimedia frames comprised in a encoded digital data stream (IS) on a computer running a multitasking operating system, said method comprising the steps of:
audio decoding and rendering (DR), to decode (ADEC) an audio stream (AS) contained in the encoded digital data stream and to render (AREN) the decoded audio frames (AF) provided by the decoding,
decoding (DEC) at least one video stream (VS) contained in the encoded digital data stream, to supply decoded video frames (VF) to a video buffer (BUF), and
rendering (REN) the decoded video frames stored in the video buffer, characterized in that said method comprises a scheduling step (SCH) for registering the previous steps, assigning a target time to said steps, and controlling the execution of the steps as a function of the target time.

2. A method of playing multimedia frames as claimed in claim 1, characterized in that the scheduling step (SCH) is adapted to control the execution of the video rendering step (REN) by skipping the rendering of video frames as a function of the target time.

3. A method of playing multimedia frames as claimed in claim 1 or 2, characterized in that the scheduling step (SCH) is adapted to control the execution of the video decoding step (DEC) by stopping the decoding at a given video frame and resuming it at a following video frame as a function of the target time.

4. A method of playing multimedia frames as claimed in claim 3, characterized in that the video decoding step (DEC) comprises a sub-step of freezing the last video frames stored in the video buffer (BUF) until the target time corresponding to a random access point in the encoded digital data stream (IS) is reached.

5. A method of playing multimedia frames as claimed in claim 1 or 3, characterized in that the scheduling step (SCH) is adapted to control the execution of the audio decoding and rendering step (DR) by skipping the audio decoding at a given audio frame and resuming it at a following audio frame as a function of the target time.

6. A method of playing multimedia frames as claimed in claim 5, characterized in that the audio decoding and rendering step (DR) comprises a sub-step of filtering (FIL) the decoded audio frames (AF) to remove noise at a beginning and end of a silence resulting from skipping of the audio decoding.

7. A computer program product for a set-top-box comprising a set of instructions which, when loaded into said set top box, causes the set-top-box to carry out the method as claimed in claims 1 to 6.

8. A computer program product for a computer comprising a set of instructions which, when loaded into said computer, causes the computer to carry out the method as claimed in claims 1 to 6.
